(19) United States
(12) Patent Application Publication
(10) Pub. No.: US 2012/0043888 A1
(43) Pub. Date: Feb. 23, 2012

(54) Vehicle Interior Light Configured to Color Correct and Method Thereof

(76) Inventors: Stuart C. Salter, White Lake, MI (US); Jeffrey Singer, Canton, MI (US); Cornel Lewis Gardner, Romulus, MI (US); Megan Lovejoy, Dearborn, MI (US); Denis Patrick Igoe, Livonia, MI (US)

(21) Appl. No.: 12/858,486

(22) Filed: Aug. 18, 2010

(51) Int. Cl. B60Q 1/14

(52) U.S. Cl. 315/77

(57) ABSTRACT

An interior light in a vehicle and method of compensating for a change of color of emitted light are provided. The interior light includes a circuit board configured to be attached to a roof support structure of the vehicle, an at least partially transparent material proximate to the circuit board and attached to the roof support structure, wherein the at least partially transparent material changes a perceived color and of light propagating there-through, and at least one light source electrically connected to the circuit board, such that the at least one light source is between the circuit board and the at least partially transparent material, wherein the at least one light source is configured to emit light that propagates through the at least partially transparent material, and further configured to compensate for the change of the color and the intensity of light propagating through the at least partially transparent material.

### FIELD OF THE INVENTION

The present invention generally relates to an interior light of a vehicle and a method, and more particularly, a hidden dome lamp that emits light through an at least partially transparent material and method thereof.

### BACKGROUND OF THE INVENTION

Lamps are generally disposed about a vehicle interior to provide light inside the automobile. Generally, lamps extend through a headliner to illuminate a cabin of the vehicle. Thus, lamps are typically designed to minimize attenuation of the light emitted from the lamp.

### SUMMARY OF THE INVENTION

Accordingly, in a first disclosed embodiment, an interior light in a vehicle is provided that includes a circuit board configured to be attached to a roof support structure of the vehicle, an at least partially transparent material proximate to the circuit board and attached to the roof support structure, wherein the at least partially transparent material changes a perceived color of light propagating there-through, and at least one light source electrically connected to the circuit board, such that the at least one light source is between the circuit board and the at least partially transparent material, wherein the at least one light source is configured to emit light that propagates through the at least partially transparent material, and further configured to compensate for the change of the color of light propagating through the at least partially transparent material.

In another disclosed embodiment, a method of compensating for a change in a perceived color of light emitted from a hidden dome lamp in a vehicle is provided that includes the steps of emitting light from at least one light source, propagating the emitted light through an at least partially transparent headliner fabric, wherein the at least partially transparent headliner fabric attenuates the emitted light propagating there-through, such that the color of the emitted light is changed, and configuring the at least one light source to compensate for the change of the color of the light propagating through the at least partially transparent headliner fabric.

In another disclosed embodiment, a hidden dome lamp in a vehicle is provided that includes an at least partially transparent headliner fabric that changes color of light propagating there-through, and at least one LED emits light that propagates through the fabric, wherein the LED is configured to compensate for the change in the color of the light propagating through the fabric.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a plan view of a vehicle having an interior vehicle light, in accordance with one embodiment of the present invention;

FIG. 2 is a perspective view of an interior cabin of a vehicle having an interior vehicle light, in accordance with one embodiment of the present invention;

FIG. 3 is an exploded perspective view of an interior vehicle light, in accordance with one embodiment of the present invention;

FIG. 4 is a perspective view of an interior cabin of a vehicle having an interior vehicle light, in accordance with one embodiment of the present invention;

FIG. 5 is a perspective view of an interior cabin of a vehicle having an interior vehicle light, in accordance with one embodiment of the present invention;

FIG. 6 is a chart illustrating the x,y color space, and comparing perceived colors of light emitted from an un-compensated interior light and an interior light in accordance with one embodiment of the present invention;

FIG. 7 is a chart illustrating LED bins of an un-compensated interior light and an interior light in accordance with one embodiment of the present invention; and

FIG. 8 is a flow chart illustrating a method of compensating for change of a perceived color of light emitted from an interior vehicle light in a vehicle, in accordance with one embodiment of the present invention.

### DETAILED DESCRIPTION OF PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

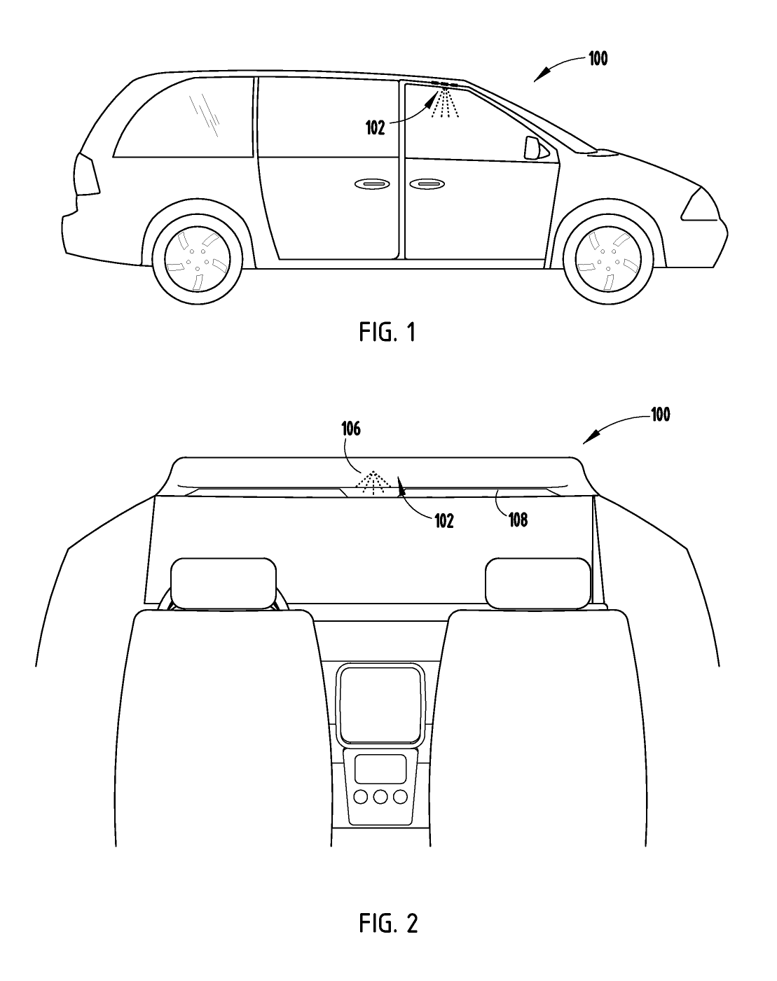

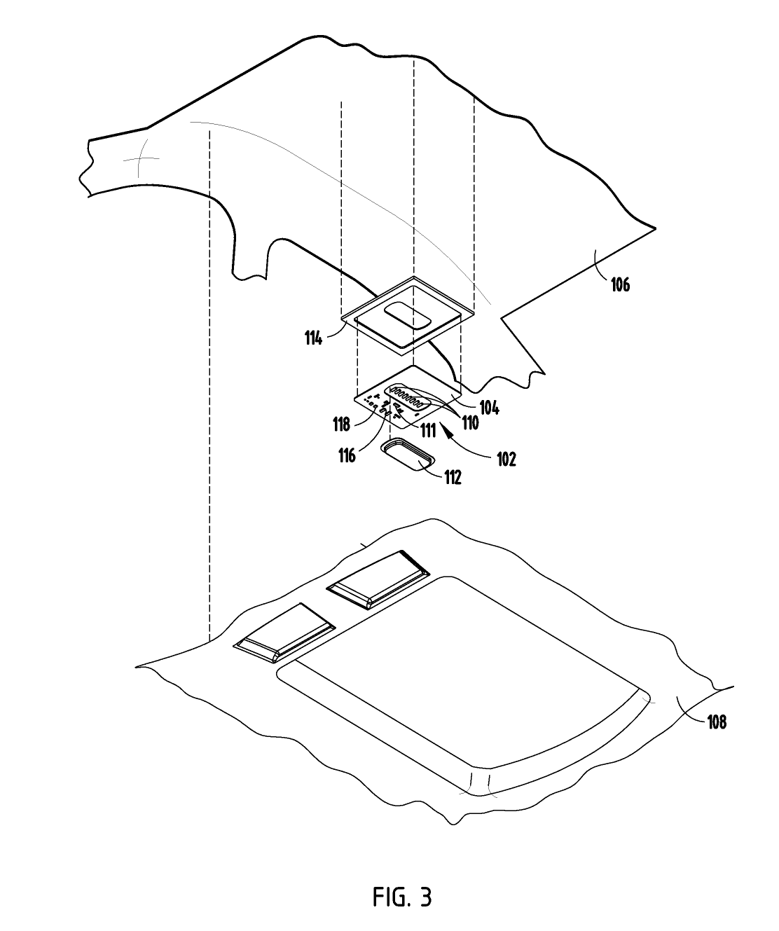

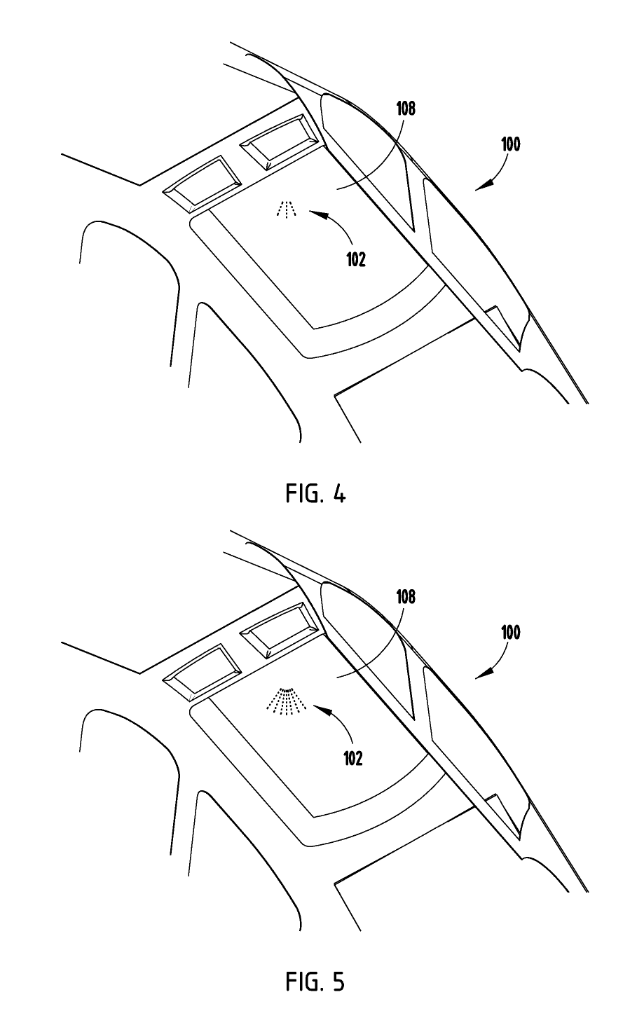

In regards to FIGS. 1-5, a vehicle is generally shown at reference identifier 100 having an interior light generally indicated at reference identifier 102. The interior light 102 can include a circuit board 104 configured to be attached to a roof support structure 106 of the vehicle 100, and an at least partially transparent material 108 proximate the circuit board 104 and attached to the roof support structure 106, wherein the at least partially transparent material 108 changes a perceived color of light propagating there-through. The interior light 102 can further include at least one light source 110 electrically connected to the circuit board 104, such that the at least one light source 110 is between the circuit board 104 and the at least partially transparent material 108, wherein the at least one light source 110 can be configured to emit light that propagates through the at least partially transparent material 108, and further configured to compensate for the change of the color of light propagating through the at least partially transparent material 108, as described in greater detail herein.

By way of explanation and not limitation, a standard dome lamp in a vehicle typically extends outwards and through the headliner, and has light emitting characteristics to adequately illuminate the interior of the vehicle, an adequate hue (an adequate color rendering), and an adequate intensity, since the emitted light only propagates through a lens of the dome lamp. Thus, the standard dome lamp is configured to minimize attenuation of the emitted light. However, the interior light 102, in accordance with one or more embodiments of the present invention, can be a hidden dome lamp, which emits light that propagates through the at least partially transparent material 108, so that when the light source 110 is turned OFF, an occupant of the vehicle 100 does not see the dome lamp, but instead sees a continuous or seamless piece of the at least partially transparent material 108. Exemplary hidden dome lamps are described in U.S. patent application Ser. No. 12/577,294 entitled “HIDDEN LAMP MANUFACTURING PROCESS,” and U.S. patent application Ser. No. 12/390,495 entitled “CONCEALED INTERIOR LIGHTS FOR AUTOMOBILE,” the entire references hereby being incorporated herein by reference.

Typically, the at least partially transparent material 108 is a headliner fabric, wherein the color, and thus, the attenuation characteristics can vary for different vehicles or vehicle models. The light emitted from the light source and propagating through the at least partially transmitted material 108 can have an adverse effect on the color of the emitted light, which can result in an undesirable light output viewed by a passenger. According to one embodiment, the at least partially transparent material 108 can be adequately translucent so that light emitted from the light source 110 can propagate through the at least partially transparent material 108 to suitably illuminate at least a portion of the vehicle's 100 interior cabin, but at least partially opaque so an occupant of the vehicle 100 does not see the light source 110 through the at least partially transparent material 108 when the light source 110 is OFF. For purposes of explanation and not limitation, the at least partially transparent material 108 can have approximately six percent (6%) transmission (i.e., the amount of light that passes there-through), and/or can be an off-white foamless prism fabric. The transmission of the at least partially transparent material 108 can be lower, such as, but not limited to, when a black foam is used. Alternatively, the transmission can be greater, such as, but not limited to, approximately fifty percent (50%) transmission.

In other words, the hue of the light viewed from the light source 110 is different than the hue of the light viewed through the at least partially transparent material 108. Therefore, the light source 110, other components of the interior light 102, or a combination thereof, can be configured to compensate for these adverse attenuation affects of the at least partially transparent material 108. According to one embodiment, the emitted light propagating through the at least partially transparent material 108 and the attenuation characteristics thereof can be the light that is viewed through the at least partially transparent material 108.

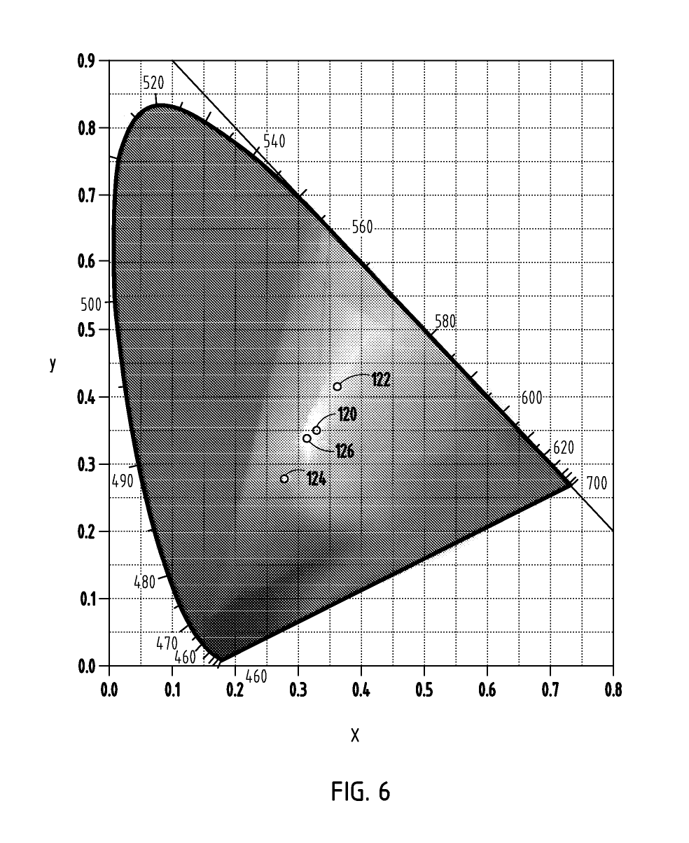

Generally, perceived color can be described with respect to various color spaces. One color space is the x,y color space (FIG. 6). It can also be useful to discuss colors with respect to the Commission Internationele de I'Eclairage's (CIE) 1976 CIELAB Chromaticity Diagram (commonly referred to the L*a*b* chart). One reference that discusses color space, in particular the L*a*b* chart, is PRINCIPLES OF COLOR TECHNOLOGY, Billmeyer and Seltzmar, 3rd edition, 2000, the entire reference hereby being incorporated herein by reference. A hue of emitted light can be a range or variation of colors within a particular color region of the color space. Another color space can be the u′,v′ color space, also referred to as the CIEUV color space, is a color space adopted by the CIE in 1976, as a way to compute transformation of the 1931 CIE XYZ color space, but which attempted perceptual uniformity. Although, the color change mostly described herein is with respect to the x,y color space, it should be appreciated by those skilled in the art that compensating for the adverse attenuation effects of the at least partially transparent material 108 can also be described in the L* a* B* and u′,v′ color spaces.

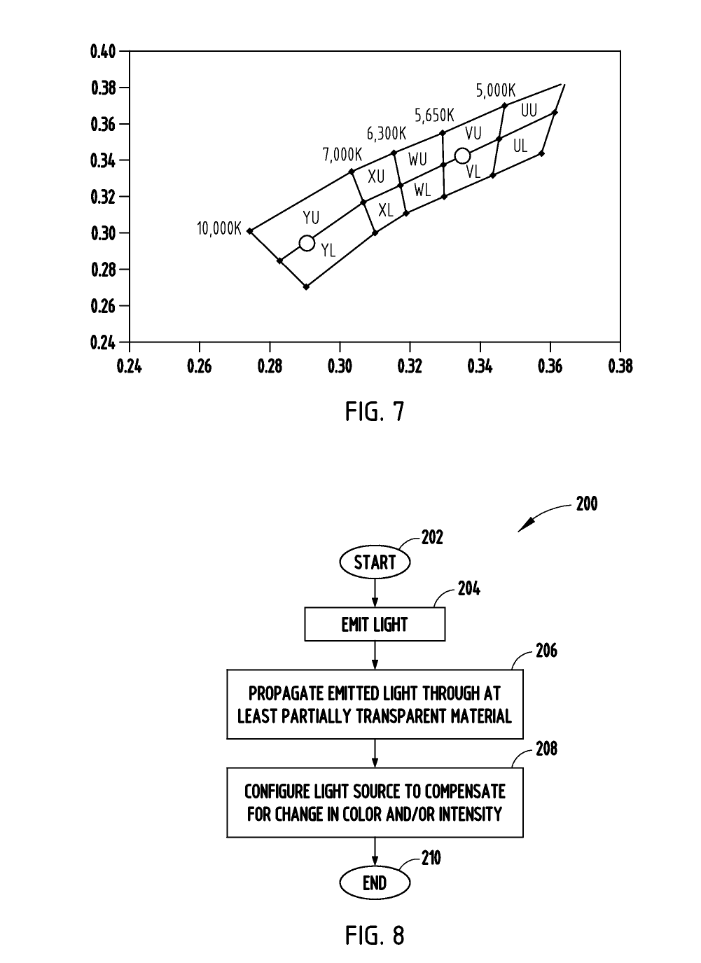

The at least one light source 110 can include at least one light emitting diode (LED), according to one embodiment. In such an embodiment, the at least one light source 110 compensates for the change of the perceived color by shifting LED bins as a function of attenuation characteristics of the at least partially transparent material 108. Thus, the LED bin shift can be based upon the attenuation characteristics of the at least partially transparent material 108. Generally, LED bins or bin coding can be used for describing specifications (e.g., operating characteristics) of an LED, and include a flux rating, a tint, a forward voltage (V_{f}), a color, or a combination thereof. Since the LED bins can include color, the LED bin chart illustrated in FIG. 7 can be overlayed with the x,y color space illustrated in FIG. 6.

For purposes of explanation and not limitation, the LED bin shift can include shifting from a W bin to a blue white Y bin. Such an exemplary bin shift can be used when the light emitted from the light source without an LED bin shift and viewed through the at least partially transparent material 108 has a greenish-white hue. It should be appreciated by those skilled in the art that the selected LED bin shift can be dependent upon the attenuation characteristics of the at least partially transparent material 108, and that other LED bin shifts can be utilized.

In such an exemplary scenario, with respect to FIG. 6, an un-compensated interior light (i.e., a light that does not implement LED bin shifting) emits light that has a perceived color that is represented by point 120 when viewed directly from the light source, and has a perceived color that is represented by point 122 when viewed after the light propagates through the headliner. Thus, a shift in perceived color goes from white light to a greenish-white hue (e.g., point 122 is in the greenish-white region of the x,y color space). The interior light 102 can include the LED bin shift, such that the light when viewed directly from the light source 110 can have a bluish hue, as represented by point 124, and the light when viewed after propagating through the at least partially transparent material 108 can appear as white light, as represented by point 126. Thus, the light originally emitted from the light source 110 is in a bluish region of the x,y color space, but appears as white when viewed through the at least partially transparent material 108.

An additional or alternative embodiment is where the at least one LED can include a plurality of red, green, and blue LEDs, and the light emitted from the red, green, and blue LEDs can be controlled to blend the emitted light as a function of the attenuation characteristics of the at least partially transparent material 108. Thus, the light emitted from the various red, green, and blue LEDs can be configured to compensate for adverse attenuation effects of the light propagating through the at least partially transparent material 108. It should be appreciated by those skilled in the art that the blending of light emitted by the red, green, and blue LEDs can be dependent upon the attenuation characteristics of the at least partially transparent material 108. It should be further appreciated by those skilled in the art that additional or alternative colors of LEDs can be used.

In such an exemplary scenario, with respect to FIG. 6, an un-compensated interior light (i.e., a light that does not implement compensating red, green, and blue LED configurations) emits light that has a perceived color that is represented by point 120 when viewed directly from the light source, and has a perceived color that is representative by point 122 when viewed after the light propagates through the headliner. Thus, a shift in perceived color goes from white light to a greenish white hue (e.g., point 122 is in a greenish-white region of the x,y color space). The interior light 102 can include specific red, green, and blue LED configurations to blend the light, such that the light when viewed directly from the light source 110 can have a bluish hue, as represented by point 124, and the light when viewed after propagating through the at least partially transparent material 108 can appear as white light, as represented by point 126. Thus, the light originally emitted from the light source 110 is in a bluish region of the x,y color space, but appears as white when viewed through the at least partially transparent material 108.

Typically, the red, green, and blue LEDs can be separate LEDs configured to emit light having different dominant wavelengths (e.g., perceived as different colors). At least a portion of the red, green, and blue LEDs can have different housings, be enclosed in a single housing, have separate components, share components, or a combination thereof.

Yet another additional or alternative embodiment is where the at least one light source 110 can be at least one LED that is a red, green, blue (RGB) LED, wherein the light emitted from the RGB LED is controlled to blend the emitted light as a function of the attenuation characteristics of the at least partially transparent material 108. Thus, the light emitted from the RGB LED can be configured to compensate for adverse attenuation effects of the light propagating through the at least partially transparent material 108. It should be appreciated by those skilled in the art that the blending of light emitted by the RGB LED can be dependent upon the attenuation characteristics of the at least partially transparent material 108. It should further be appreciated by those skilled in the art that additional or alternative colors can be included in the LED.

In such an exemplary scenario, with respect to FIG. 6, an un-compensated interior light (i.e., a light that does not implement a compensating RGB LED) emits light that has a perceived color that is represented by point 120 when viewed directly from the light source, and has a perceived color that is represented by point 122 when viewed after the light propagates through the headliner. Thus, a shift in perceived color goes from white light to a greenish-white hue (e.g., point 122 is in a greenish-white region of the x,y color space). The interior light 102 can include the configured RGB LED, such that the light when viewed directly from the light source 110 can have a bluish hue as represented by point 124, and the light when viewed after propagating through the at least partially transparent material 108 can appear as white light, as represented by point 126. Thus, the light originally emitted from the light source 110 is in a bluish region of the x,y color space, but appears as white when viewed through the at least partially transparent material 108.

Typically, the RGB LED includes multiple semiconductor dies enclosed in a single housing (e.g., a red semiconductor die, a green semiconductor die, and a blue semiconductor die). However, it should be appreciated by those skilled in the art that separate components can be used in the RGB LED.

In an embodiment of the interior lamp 102 that compensates for the adverse attenuation effects of the at least partially transparent material 108 by controlling the light emitted from one or more light sources (e.g., red, green, and blue LED or a RGB LED), the interior lamp 102 can include a controller 111. The controller 111 can be configured to receive an instruction and/or execute one or more executable software routines to control the light emitted from the light source 110. Thus, the controller 111 can be electrically connected to the circuit board 104 and in communication with the light source 110.

For purposes of explanation and not limitation, the light source 110 can be configured once at the time of manufacturing the vehicle 100 based upon the vehicle or vehicle model and the selected at least partially transparent material 108. Thus, the same light source 110 can be configured for all vehicles 100, and the light emitting characteristics of the light source 110 can be configured during manufacturing of the vehicle 100 by programming or activating/de-activating one or more executable software routines on the controller 111. However, it should be appreciated by those skilled in the art that the controller 111 can be re-programmed or otherwise control the light source 111 to alter the light emitting characteristics after manufacturing the vehicle 100 is complete.

According to another additional or alternative embodiment, the light source 110 can include a filter 112 configured to compensate for the change of the perceived color of the emitted light propagating through the at least partially transparent material 108. Thus, the light emitted from the light source 110 and propagated through the filter 112 can be configured to compensate for adverse attenuation effects of the light propagating through the at least partially transparent material 108. It should be appreciated by those skilled in the art that the optical characteristics of the filter 112 can be dependent upon the attenuation characteristics of the at least one partially transparent material 108. It should further be appreciated by those skilled in the art that the filter can be an un-alterable filter, an alterable filter (e.g., a liquid crystal display (LCD)), or a combination thereof.

In such an exemplary scenario, with respect to FIG. 6, an un-compensated interior light (i.e., a light that does not include a filter) emits light that has a perceived color that is represented by point 120 when viewed directly from the light source, and has a perceived color that is represented by point 122 when viewed after the light propagates through the headliner. Thus, a shift in the perceived color goes from white light to a greenish-white hue (e.g., point 122 is in a greenish-white region of the x,y color space). The interior light 102 can include the light source 110 and filter 112, such that light when viewed directly from the light source 110 can have a bluish hue, as represented by point 124, and the light when viewed after propagating through the filter 112 and the at least partially transparent material 108 can appear as white light, as represented by point 126. Thus, the light originally emitted from the light source 110 is in a bluish region of the x,y color space, but appears as white when viewed through the at least partially transparent material 108.

It should be appreciated by those skilled in the art that the adverse attenuation characteristics of the at least partially transparent material 108 compensated for by a configuration of the light source 110 can include other characteristics in addition to or in alternative to perceived color correction. Exemplary adverse attenuation characteristics can include intensity, readability, the like, or a combination thereof.

According to one embodiment, the light source 110 can be electrically connected to the circuit board 104 and the circuit board 114 can be attached to a frame structure 114. The framing structure 114 can be attached to the roof structure 106, and the at least partially transparent material 108 can extend along the roof structure 106 to cover the circuit board 104, the light source 110, and the framing structure 114. It should be appreciated by those skilled in the art that components that are attached can be directly or indirectly (i.e., one or more intermediate components) attached, according to one embodiment. In an embodiment that utilizes the filter 112, the at least partially transparent material 108 can also cover the filter 112.

Typically, when the interior lamp 102 is a hidden dome lamp, the light source 110 can be activated to be ON or OFF by a proximity switch 116. The proximity switch 116 detects a touch or that an object is proximate thereto. By way of explanation and not limitation, the proximity switch can be, but is not limited to, a capacitive switch, a resistive switch, an inductive switch, an optical switch, a thermal switch, the like, or a combination thereof.

Additionally, the interior lamp 102 can include an indicator light source 118, which can emit light only when the light source 110 is OFF or the indicator light source 118 can continuously emit light. Typically, the indicator light source 118 is a low powered LED; however, it should be appreciated by the skilled in the art that one or more suitable light sources can be used. The indicator light source 118 can be electrically connected to the circuit board 104 adjacent the proximity switch 116 to indicate a location of the proximity switch 116. Thus, if a user moves an object (e.g., the user's hand) proximate the indicator light source 118, the proximity switch 116 detects the object and activates or de-activates the light source 110. The indicator light source 118 can be configured to compensate for attenuation effects of the light propagating through the at least partially transparent material 108, as described herein with respect to the light source 110.

In regards to FIGS. 1-5 and 8, a method of compensating for a change in at least one of color and intensity of light emitted from the hidden dome lamp 102 and the vehicle 100 is generally shown in FIG. 8 at reference identifier 200. The method 200 can start at step 202, and proceed to step 204, wherein light is emitted. At step 206 the emitted light propagates through the at least partially transparent material 108. At step 208, the light source 110 can be configured to compensate for a change in color and/or intensity, and the method can end at step 210. As described above, the light source 110 can be configured to compensate for the adverse attenuation characteristics of the at least partially transparent material 108 by shifting LED bins configuring red, green, and blue LEDs, configuring a RGB LED, including a filter, or a combination thereof.

Advantageously, the interior light 102 and the method 200 can adequately compensate for adverse attenuation effects of light propagating through the at least partially transparent material 108. In prior art dome lamps, the dome lamps extended outwards from the roof structure and were not covered by the headliner material, and thus, the light emitted from the light source only propagated through a lens; however, the hidden dome lamp 102 emits light that propagates through the headliner fabric that hides the hidden dome lamp 102 when not in use. Thus, the light source of the hidden dome lamp 102 is configured to compensate for one or more adverse attenuation effects of the at least partially transparent material 108. Typically, the light source 110 is configured to compensate for adverse color rendering. It should be appreciated by those skilled in the art that additional or alternative advantages can be present from the interior light 102 and the method 200. It should further be appreciated by those skilled in the art that the above-described components can be combined in additional or alternative ways not explicitly described herein.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. An interior light in a vehicle, said interior light comprising:
a circuit board configured to be attached to a roof support structure of the vehicle;
an at least partially transparent material proximate to said circuit board and attached to the roof support structure, wherein said at least partially transparent material changes a perceived color of light propagating there-through; and
at least one light source electrically connected to said circuit board, such that said at least one light source is between said circuit board and said at least partially transparent material, wherein said at least one light source is configured to emit light that propagates through said at least partially transparent material, and further configured to compensate for said change of said color of light propagating through said at least partially transparent material.

2. The interior light of claim 1, wherein said at least one light source comprises at least one light emitting diode (LED).

3. The interior light of claim 2, wherein said at least one light source compensates for said change of said color by shifting LED bins as a function of attenuation characteristics of said at least partially transparent material.

4. The interior light of claim 3, wherein said LED bin shift comprises shifting from a W bin to a Y bin.

5. The interior light of claim 2, wherein said at least one LED comprises a plurality of red, green, and blue LEDs, and said light emitted from said red, green, and blue LEDs is controlled to blend said emitted light as a function of attenuation characteristics of said at least partially transparent material.

6. The interior light of claim 2, wherein said at least one LED is a red, green, and blue (RGB) LED, and said light emitted from said RGB LED is controlled to blend said emitted light as a function of attenuation characteristics of said at least partially transparent material.

7. The interior light of claim 1, wherein said at least one light source comprises a filter configured to compensate for said change of said color of said emitted light propagating through said at least partially transparent material.

8. The interior light of claim 1, wherein said at least partially transparent material is a headliner fabric.

9. The interior light of claim 8 being a hidden dome lamp.

10. A method of compensating for a change of color of light emitted from a hidden dome lamp in a vehicle, said method comprising the steps of:
emitting light from at least one light source;
propagating said emitted light through an at least partially transparent headliner fabric, wherein said at least partially transparent headliner fabric attenuates said emitted light propagating there-through, such that a perceived color of said emitted light is changed;
configuring said at least one light source to compensate for said change of said color of light propagating through said at least partially transparent headliner fabric.

11. The method of claim 10, wherein said at least one light source comprises at least one light emitting diode (LED).

12. The method of claim 11, wherein said step of configuring said at least one light source comprises:
shifting LED bins as a function of attenuation characteristics of said at least partially transparent headliner fabric.

13. The method of claim 12, wherein said step of shifting LED bins comprises:
shifting from a W bin to a Y bin.

14. The method of claim 11, wherein said step of configuring said at least one light source comprises:
providing said at least one LED comprising a plurality of red, green, and blue LEDs, and said light emitted from said red, green, and blue LEDs is controlled to blend said emitted light as a function of attenuation characteristics of said at least partially transparent headliner fabric.

15. The method of claim 11, wherein said step of configuring said at least one light source comprises:
providing said at least one LED that is a red, green, and blue (RGB) LED, and said light emitted from said RGB LED is controlled to blend said emitted light as a function of attenuation characteristics of said at least partially transparent headliner fabric.

16. The method of claim 11, wherein said step of configuring said at least one light source comprises:
providing said at least one light source that comprises a filter configured to compensate for said change of said color of said emitted light propagating through said at least partially transparent headliner fabric.

17. A hidden dome lamp in a vehicle comprising:
an at least partially transparent headliner fabric that changes a perceived color of light propagating there-through; and
at least one LED emits light that propagates through said fabric, wherein said LED is configured to compensate for said change in color of light propagating through said fabric.

18. The hidden dome lamp of claim 17, wherein said LED compensates for said change in color by shifting LED bins as a function of attenuation characteristics of said fabric.

19. The hidden dome lamp of claim 17, wherein said LED comprises at least one of a red, green, and blue LED and a plurality of red, green, and blue LEDs, wherein said RGB light is blended as a function of attenuation characteristics of said fabric.

20. The hidden dome lamp of claim 17, wherein said LED comprises a filter configured to compensate for said change in color of said emitted light propagating through said at least partially transparent material.
